(19) United States
(12) Patent Application Publication
(10) Pub. No.: US 2026/0146689 A1
(43) Pub. Date: May 28, 2026

(54) PRESS-STYLE FITTINGS AND SYSTEMS, KITS, AND METHODS INCORPORATING THE SAME

(71) Applicant: Titeflex Corporation, Springfield, MA (US)

(72) Inventors: Connor Welcome, Portland, TN (US); Jordan Strunk, Portland, TN (US); Paul Beshear, Springfield, TN (US)

(73) Assignee: Titeflex Corporation, Springfield, MA (US)

(21) Appl. No.: 19/333,694

(22) Filed: Sep. 19, 2025

Related U.S. Application Data
(60) Provisional application No. 63/725,358, filed on Nov. 26, 2024.

(51) Int. Cl. F16L 13/14; B21D 39/04; F24F 1/0326; F25B 41/40

(52) U.S. Cl. CPC F16L 13/141; B21D 39/046; F24F 1/0326; F25B 41/40

(57) ABSTRACT

An aspect of the invention provides a method for installing a malleable crimping sleeve over a fitting. The method includes: providing a tube having a composite HVAC/R line set tubing; advancing a cut end of the tube over the nipple of a fitting as described herein; placing a crimping jaw over the malleable crimping sleeve and the cut end of the tube; and applying force to the crimping jaw, thereby forming a gas-tight seal between the cut end of the tube and the fitting and deforming the cut end of the tube to impart a radial deflection between 0.012 and 0.040 inches (0.305 and 1.016 mm) relative to its pre-crimping state.

### CROSS-REFERENCE TO RELATED APPLICATION(S)

This application claims the benefit of priority under 35 U.S.C. § 119(e) to U.S. Provisional Patent Application Ser. No. 63/725,358, filed Nov. 26, 2024. The entire content of this application is hereby incorporated by reference herein.

### BACKGROUND OF THE INVENTION

Multilayer composite pipes are designed and used to convey liquids, primarily water, for applications such as in floor heating, radiator heating, and water supply.

### SUMMARY OF THE INVENTION

One aspect of the invention provides a fitting including: a nipple including a first annular groove along a radially-outer surface of the nipple, a second annular groove distal to the first annular groove, the second annular groove also along the radially-outer surface of the nipple, and a distal end distal to the first annular groove and the second annular groove; a malleable crimping sleeve positioned radially over at least a portion of the first annular groove, the second annular groove, and the distal end of the of the nipple, the malleable crimping sleeve including a locking rib adapted and configured to sit radially over, but not within the first annular groove of the nipple when in an uncrimped state and engage with the first annular groove of the nipple upon crimping; and a retaining ring seated within the second annular groove of the nipple and engaged with complementary geometry of the malleable crimping sleeve to distally retain the malleable crimping sleeve such that the locking rib sits radially over, but not within the first annular groove of the nipple when in an uncrimped state. The distal end of the nipple is adapted and configured for insertion within a cut end of tubing having a complementary inner diameter.

This aspect of the invention can have a variety of embodiments. The retaining ring can be a split bushing seated on a radially outer surface of the nipple. The fitting can be metal. The fitting can further include a swivel end that defines a conical profile. The conical profile can have a 45° slope. A gasket can be inserted into the conical profile.

The nipple can include additional annular grooves. The nipple can include additional retaining rings seated within the additional annular grooves. The additional retaining rings can include O-rings.

The nipple can define a plurality of barbs on a radially outer surface of the nipple.

Another aspect of the invention provides a kit including: a fitting as described herein; and a length of composite HVAC/R line set tubing.

This aspect of the invention can have a variety of embodiments. The kit can further include instructions for attaching the fitting to the length of composite HVAC/R line set tubing. The kit can further include a crimping jaw complementary to the malleable crimping sleeve. The crimping jaw includes one or more annular crimping points and one or more alignment bosses.

Another aspect of the invention provides a system including: a length of composite HVAC/R line set tubing; and a fitting as described herein coupled to at least one end of the length of composite HVAC/R line set tubing.

Another aspect of the invention provides a method for installing a malleable crimping sleeve over a fitting. The method including: providing a tube having a composite HVAC/R line set tubing; advancing a cut end of the tube over the nipple of a fitting as described herein; placing the malleable crimping sleeve of the fitting over the cut end of the tube such that: the locking rib of the malleable crimping sleeve is engaged with the first annular groove of the nipple upon crimping, and the retaining ring of the fitting is seated within the second annular groove of the nipple and engaged with complementary geometry of the malleable crimping sleeve to distally retain the malleable crimping sleeve such that the locking rib sits radially over; placing a crimping jaw over the cut end of the tube, such that one or more crimping points and corrugation valleys are radially over the first annular groove and the tube; and applying force to the crimping jaw, thereby forming a gas-tight seal between the cut end of the tube and the fitting.

Another aspect of the invention provides a fitting including: a nipple including a distal end distal to a first annular groove and a second annular groove of the nipple, the distal end adapted and configured for insertion within a cut end of a tube having a complementary inner diameter, and one or more annular grooves along a radially-outer surface of the nipple; a malleable crimping sleeve positioned radially over at least a portion of the one or more annular grooves, wherein the malleable crimping sleeve is configured to compress the cut end of the tube onto the one or more annular grooves to allow for deformation of the cut end of the tube such that a diameter of the cut end of the tube has a radial deflection between 0.012 and 0.040 inches (0.305 and 1.016 mm) relative to its pre-crimping state.

This aspect of the invention can have a variety of embodiments. The malleable crimping sleeve can further include one or more complementary projections on a radially-surface, the one or more complementary projections axially aligned relative to the one or more annular grooves.

Another aspect of the invention provides a kit including: a fitting as described herein; and a length of composite HVAC/R line set tubing.

This aspect of the invention can have a variety of embodiments. The crimping points of the crimping jaw can be axially aligned relative to the one or more annular grooves.

Another aspect of the invention provides a method for installing a malleable crimping sleeve over a fitting. The method includes: providing a tube having a composite HVAC/R line set tubing; advancing a cut end of the tube over the nipple of a fitting as described herein; placing a crimping jaw over the malleable crimping sleeve and the cut end of the tube; and applying force to the crimping jaw, thereby forming a gas-tight seal between the cut end of the tube and the fitting and deforming the cut end of the tube to impart a radial deflection between 0.012 and 0.040 inches (0.305 and 1.016 mm) relative to its pre-crimping state.

### BRIEF DESCRIPTION OF THE DRAWINGS

FIGS. 1A-1B are diagrammatic illustrations of a press-style fitting, according to one or more embodiments.

FIG. 2 is diagrammatic illustration of an exploded view of the press-style fitting of FIGS. 1A-1B, according to one or more embodiments.

FIG. 3 is an illustrative representation of the press-style fitting of FIGS. 1A-1B with a cut end of a tube, according to one or more embodiments.

FIG. 4 depicts a method for installing tubing onto the press-style fitting of FIGS. 1A-1B, according to one or more embodiments.

FIG. 5 depicts a method for installing tubing onto the press-style fitting of FIG. 3, according to one or more embodiments.

FIG. 6 depicts a typical heating, ventilation, air-conditioning, and refrigeration (HVACR) system, according to one or more embodiments.

### DETAILED DESCRIPTIONS

Aspects of the invention provide crimp fittings and systems, kits, and methods incorporating the same. The crimp fittings advantageously provide an integral fitting that does not require any disassembly or reassembly or turning of nuts, thereby reducing installation time and avoiding the need to use a second wrench to hold one part of a fitting while advancing a nut. Aspects of the invention also provide assembly and/or installation of a fitting and tubing at a factory or point of manufacture.

Aspects of the invention provide a press-style fitting that can utilize a 45° flare swivel connection. In some embodiments, the press-style fitting as described herein can include a crimp sleeve and a nipple in which the crimp sleeve includes locking ribs that locks onto the nipple. The nipple can include barbs and/or pockets for smooth and secure locking and unlocking. The barbs can hold retaining rings (e.g., O-rings, split bushing, etc.) for insulation against dissimilar metals and the barbs can be made from brass, aluminum, or stainless steel.

The press-style fitting can be mated with line set tubing such as a composite HVAC/R line-set tubing and/or a composite refrigeration line set. In some embodiments, the line set tubing can include an inner plastic tube, a first adhesive layer positioned about the inner plastic tube, an aluminum layer positioned about the first adhesive layer and coupled to the inner plastic tube via the first adhesive layer, a second adhesive layer positioned about the aluminum layer, and an outer plastic layer positioned about the aluminum layer coupled to the aluminum layer via the second adhesive layer. The inner plastic tube and/or outer plastic tube can be polyethylene (PE), polyethylene or raised temperature (PE-RT), polyethylene-fiberglass composite, polyamide (e.g., nylon), and the like. The aluminum layer can include an alloy selected from the group consisting of AL 3004-O, AL 3005-O, and AL 3555-O. In some cases, the aluminum layer can be butt-welded to itself. The composite refrigeration line set can further include a low-emissivity layer positioned about the outer plastic layer. The low-emissivity layer can include low-emissivity aluminum. The low-emissivity layer can include a metallized film. In some cases, the composite refrigeration line set tube can have a burst pressure in excess of 2100 pounds per square inch. The composite refrigeration line set can further include a reinforcement layer.

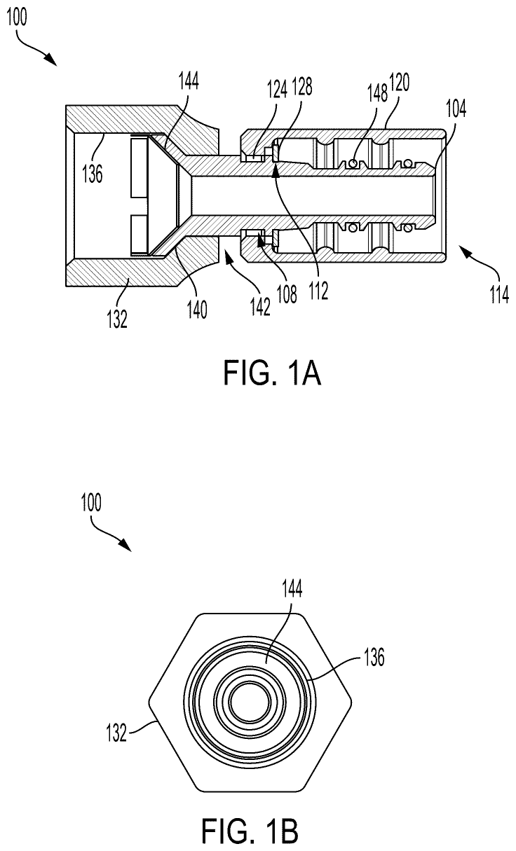

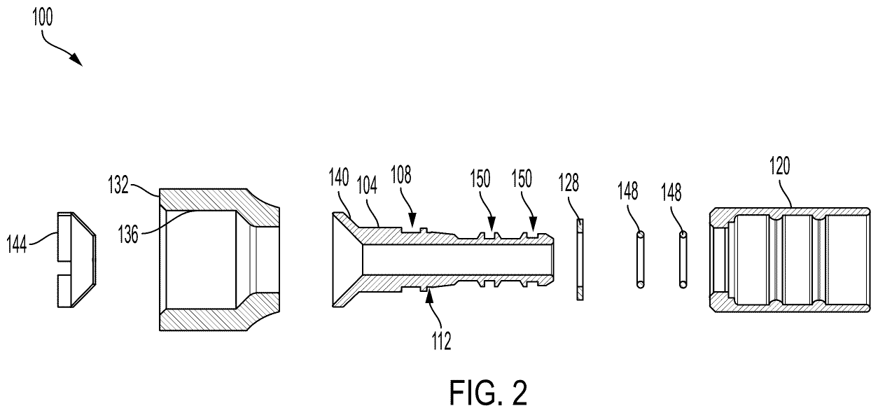

FIGS. 1A-1B are diagrammatic illustrations of a press-style fitting 100, according to one or more embodiments. FIG. 1A illustrates a diagrammatic representation of a cross-section of the fitting 100. FIG. 1B illustrates a diagrammatic representation of the fitting 100 from a proximal view. FIG. 2 is diagrammatic illustration of an exploded view of the press-style fitting 100 of FIGS. 1A-1B, according to one or more embodiments. The fitting 100 can be made of metallic materials. The fitting 100 can include a nipple 104, a crimping sleeve 120, one or more retaining rings 128, and/or a swivel nut 132. The fitting 100 can be a female or a male swivel fitting (as defined by whether the swivel nut 132 has threads a radially inner or outer surface, respectively) and installed at a point of manufacture or in the field. In some implementations, the press-style fitting 100 described herein can be used with other types of opposing connections, such as, for example, a braze-on connection, press-tool connection, compression connection, and the like.

In some implementations, the nipple 104 can include a first annular groove 108 along a radially-outer surface of the nipple 104. The nipple 104 can include a second annular groove 112 that is distal to the first annular groove 108. The second annular groove 112 can be along the radially-outer surface of the nipple 104. The nipple 104 can also include one or more barbs or ridges to resist pullback of tubing from nipple 104. In some implementations, the nipple can have additional annular grooves.

The nipple 104 can be on an opposite end of the fitting 100 from the swivel nut 132. The nipple 104 can fit freely within an inner diameter of the length of a tubing (not shown in FIG. 1A) or can be sized to fit snuggly within the tubing, e.g., requiring some force to advance the tubing and/or the fitting 100. In some cases, the first annular groove 108 and the second annular groove 112 be configured to facilitate alignment with the crimping sleeve 120 and the width and diameter of the crimping sleeve 120 can be sized to provide adequate holding power when a tubing is crimped to prevent loosening of the fitting 100.

In some implementations, a distal end 114 of the fitting 100 can be distal to the first annular groove 108 and the second annular groove 112. The distal end 114 can be adapted and configured for insertion within a cut end of a tubing (not shown in FIG. 1A) having a complementary inner diameter. For example, the distal end 114 of the nipple 104 can have a tapered, beveled, or rounded end to facilitate insertion within tubing.

In some implementations, the crimping sleeve 120 can be a malleable crimping sleeve. The crimping sleeve 120 can be positioned radially over at least a portion of the first annular groove 108, the second annular groove 112, and the distal end 114 of the nipple 104. In some implementations, the crimping sleeve 120 can include a locking rib 124. The locking rib 124 can be adapted and configured to sit radially over, but not within the first annular groove 108 when in an uncrimped state. In some implementations, the locking rib 124 can be adapted and configured to engage with the first annular groove 108 upon crimping. The depth of the first annular groove 108 can be deeper than the second annular grove 112 and/or other distal annular grooves in order to facilitate axial engagement of the locking rib 124 of the crimping sleeve 120 both before and during crimping for alignment.

In some implementations, the retaining ring 128 can be seated within the second annular groove 112 and engaged with complementary geometry of the crimping sleeve 120 to distally retain the crimping sleeve 120 such that the locking rib 124 sits radially over, but not within the first annular groove 108 when in an uncrimped state. This allows for the crimping sleeve 120 be installed during manufacturing and prevented from sliding off toward distal end 114 by retaining ring 128.

In some cases, the retaining ring 128 can be a split bushing, an O-ring, or the like. The retaining ring 128 can prevent malleable crimping 120 sleeve from falling off the nipple 104 before crimping. For example, the retaining ring 128 can deform or stretch to engage prior to seating in groove 112. Such deformation can be facilitated, e.g., by a tapered region distal to second annular groove 112 as depicted in FIGS. 1A and 2, by heating retaining ring 128 and/or cooling nipple 104 to induce expansion or contraction, respectively, of those parts to allow for assembly, and the like.

The nipple 104 can include one or more additional retaining rings 148 such as, for example, O-rings, to resist pullback and/or provide a gas-tight seal. In some cases, additional annular grooves 150 can be without an O-ring to provide additional mechanical holding power.

In some implementations, the fitting 100 can also include a swivel nut 132. The swivel nut 132 can include a threaded region 136 adapted and configured to be installed with onto a complementary threaded device (not shown in FIG. 1B). In some cases, the threaded region 136 can include female threads, male threads, or other geometries for coupling, and can be sized to mate with common pipe sizes (e.g., ½″, ¾″, 1″, 1¼″, 1½″, 2″ Nominal Pipe Size). The swivel nut 132 can have wrench flats such as a hexagonal region on an outer surface of the swivel nut 132 such that the flats allows for tightening of the threaded region 136 into a complementary device (e.g., a flare fitting, a male flare fitting, a tubing) using a wrench, pliers, or other tool. In some implementations, the swivel nut 132 can include a radially outer distal stop shoulder 140 that can be rotatably retained within a radially outer neck 142 of the swivel nut 132. In some implementations the radially outer neck 142 can have an outer diameter less than each of the radially outer distal stop shoulder 140.

In some implementations, a gasket 144 can be inserted to plug a channel inside the fitting 100. In some implementations, the gasket 144 can include any seal configured to fill the area defined by the radially outer distal stop shoulder 140 to form a gas-tight seal against the sealing surface radially outer distal stop shoulder 140. In some cases, the gasket 144 can be metallic and/or plastic. The gasket 144 can have a complementary profile, e.g., a 45° conical shape with a central bore to allow fluids to flow through the fitting 100. The fitting 100 can include a conical profile (e.g., a 45° conical shape) to allow for the gasket 144 to be inserted. The gasket 144 can be compressible to facilitate a gas-tight seal. Exemplary materials includes elastomers and soft metals such as copper. In some embodiments, the one or more surfaces of the gasket 144 can be coated with a liquid such as a sealant and/or lubricant. Such coating can both enhance sealing and retain the gasket 144, e.g., by adhesion or surface tension, against a flared surface.

In some embodiments, the fitting 100 can be part of a kit and/or system that also includes a length of a tubing such as, for example, a composite HVAC/R line set tubing, and instructions for attaching the fitting 100 to the length of composite HVAC/R line set tubing. In some cases, the kit can also include a crimping jaw that is complementary to the crimping sleeve 120 of the fitting 100. The crimping jaw can include one or more annular crimping points and/or one or more alignment bosses.

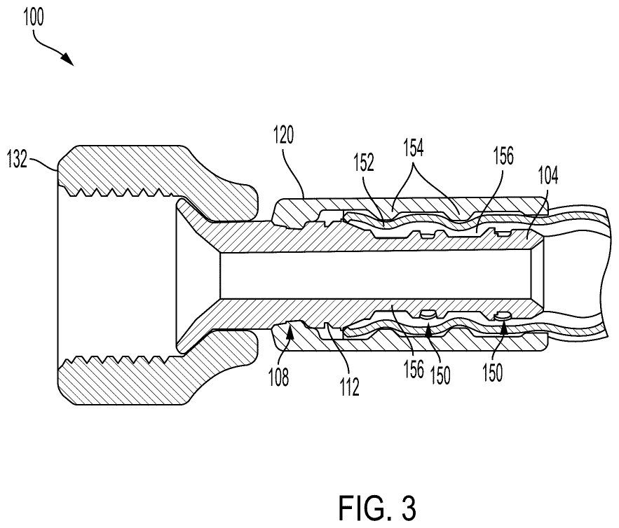

FIG. 3 is an illustrative representation of the press-style fitting 100 of FIGS. 1A-1B with a cut end of a tube along a longitudinal cross-sectional plane, according to one or more embodiments. As shown in FIG. 3, the fitting 100 includes a nipple 104 having a distal end distal to the first annular groove 108 and a second annular groove 112. The distal end can be adapted and configured for insertion within a cut end of tube 152 having a complementary inner diameter. In addition to the one or more annular grooves 150 containing O-rings, the nipple 104 can further include unfilled annular grooves 156 along a radially-outer surface of the nipple 104. The fitting 100 can include a malleable crimping sleeve 120 positioned radially over at least a portion of the one or more annular grooves 150 and/or 156. The malleable crimping sleeve 120 can be configured to compress the cut end of the tube 152 into the one or more annular grooves 156 to allow for deformation of the cut end of the tube such that a diameter of the cut end of the tube has a radial deflection between 0.012 and 0.040 inches (0.305 and 1.016 mm) relative to its pre-crimping state. The deformation can result in a shape that mimics the profile of the nipple 104 and/or crimped sleeve 120 based on the one or more annular grooves 150, 156 and/or barbs that radially surround the outer surface of the nipple 104. In some cases, the crimping sleeve 120 can include one or more complementary projections 154 (e.g., annular, points, and the like) on a radially-inner surface of the malleable crimping sleeve 120 that axially align with the one or more annular grooves 150 to result in the radial deflection. In other embodiments, the malleable crimping sleeve can have a uniform cylindrical geometry prior to crimping and the crimping jaw can be aligned to preferentially deform the sleeve over the annular grooves 156 in order to deform the tube 152. The deformed cut end of the tube 154 can then provide a grip onto the nipple 104 and can be prevented from decoupling due to the radial deflection of the tube 152 and the inner radial shoulders 154 of the crimping sleeve 120 and/or the annular grooves 156.

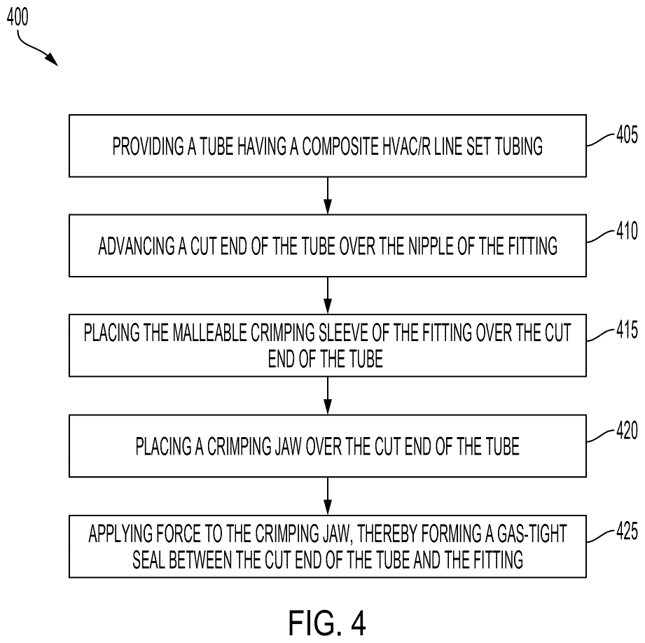

FIG. 4 depicts a method 400 for installing tubing onto the press-style fitting of FIGS. 1A-1B, according to one or more embodiments. In some implementations, the method 400 can include a method for installing a fitting and a malleable crimping sleeve over a cut end of a tube.

At 405, the method 400 includes providing a tube, e.g., a composite HVAC/R line set tubing, e.g., as sold under the PYTHON™ trademark from Titeflex Corporation of Springfield, Massachusetts and/or as described in U.S. Patent Application Publication Nos. US 2020/0400251, US 2021/0207744, US 2022/0032571, and US 2024/0133599.

At 410, the method 400 includes advancing a cut end of the tube over the nipple of the fitting of FIGS. 1A-1B. The malleable crimping sleeve can have been installed during manufacture as discussed herein such that the malleable crimping sleeve sits over an outer surface of the cut end of the tube such that the cut end of the tube is sandwiched between the nipple and the malleable crimping sleeve.

At 415, the method 400 includes placing the malleable crimping sleeve of the fitting over the cut end of the tube. In some implementations, the locking rib of the malleable crimping sleeve can be engaged with the first annular groove of the nipple upon crimping. In some implementations, the retaining ring of the fitting can be seated within the second annular groove of the nipple and engaged with complementary geometry of the malleable crimping sleeve to distally retain the malleable crimping sleeve such that the locking rib sits radially over.

At 420, the method 400 includes placing a crimping jaw over the cut end of the tube. In some implementations, one or more crimping points and corrugation valleys can be radially over the first annular groove and the tube. In some cases, the crimping jaws can include an alignment feature such an axial thickness that presses against nut and presses the malleable crimping sleeve distally against the retaining ring such that the locking rib sits radially over the first annular groove.

At 425, the method 400 includes applying force to the crimping jaw, thereby forming a gas-tight seal between the cut end of the tube and the fitting.

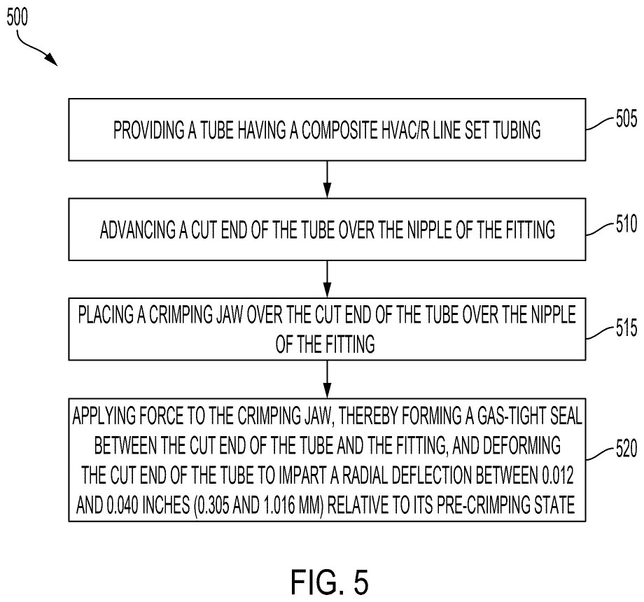

FIG. 5 depicts a method 500 for installing tubing onto the press-style fitting of FIG. 3, according to one or more embodiments. In some implementations, the method 500 can include a method for installing fitting and a malleable crimping sleeve over a cut end of a tube.

At 505, the method 500 includes providing a tube, e.g., a composite HVAC/R line set tubing as described herein.

At 510, the method 500 includes advancing a cut end of the tube over the nipple of the fitting of FIG. 3. The malleable crimping sleeve can have been installed during manufacture as discussed herein such that the malleable crimping sleeve sits over an outer surface of the cut end of the tube such that the cut end of the tube is sandwiched between the nipple and the malleable crimping sleeve.

At 515, the method 500 includes placing a crimping jaw over the cut end of the tube. In some cases, the crimping jaw can include an alignment feature such an axial thickness that presses against nut and presses the malleable crimping sleeve distally such that the locking rib sits radially over the cut end of the tube and over the nipple.

At 520, the method 500 includes applying force to the crimping jaw, thereby forming a gas-tight seal between the cut end of the tube and the fitting, deforming the cut end of the tube to impart a radial deflection between 0.012 and 0.040 inches (0.305 and 1.016 mm) relative to its pre-crimping state.

### HVACR Systems and Refrigerants

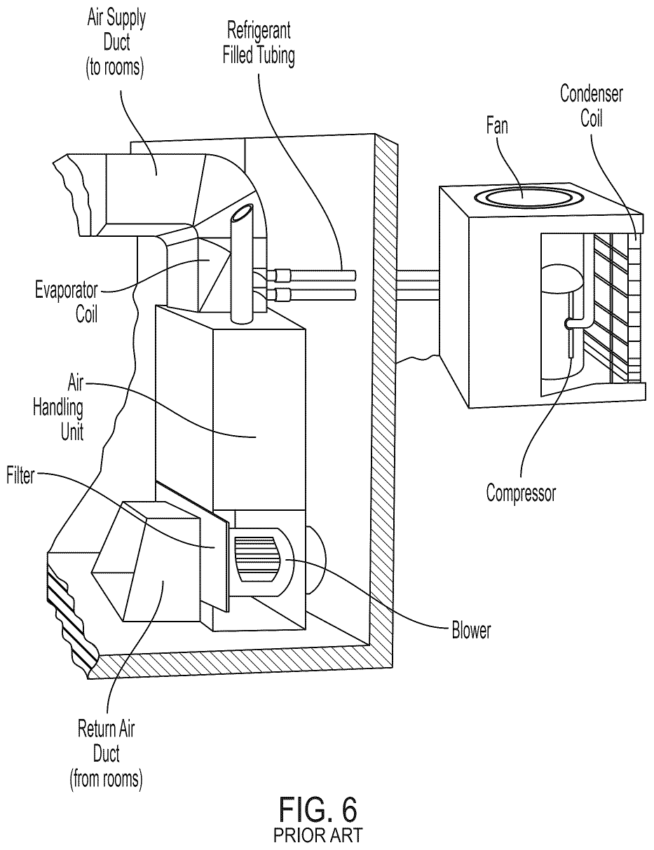

In some embodiments, aspects of the invention can include a refrigeration system (shown in FIG. 6) including a compressor, an evaporator coil, and a refrigerant. The composite refrigeration line set as described herein can be coupled between the compressor and the evaporator coil to form a fluid circuit between the compressor and the evaporator coil. The refrigerant can be received within the fluid circuit.

The refrigerant can be an A2L refrigerant.

Refrigerants are listed by the American Society of Heating, Refrigeration, and Air Conditioning Engineers (ASHRAE) in ASHRAE Standard 34 (2019). The ASHRAE 34 Standard Committee determines toxicity and flammability classification. Class A refrigerants have lower toxicity. Class B refrigerants have higher toxicity. Flammability classifications are summarized in Table 6-1 of ASHRAE Standard 34. Embodiments of the invention can be utilized with A1, A2L, A2, A3, B1, B2L, B2, or B3 refrigerants.

A Class 2L refrigerant is understood according to ASHRAE Standard 34 (2019); specifically, under § 6.1.3.2 of ASHRAE Standard 34 (2019) a Class 2L refrigerant meets all four of the following conditions: (1) exhibits flame propagation when tested at 140° F. (60° C.) and 14.7 psia (101.3 kPa); (2) has an LFL>0.0062 lb/ft³ (0.10 kg/m³); (3) has a heat of combustion <8169 Btu/lb (19,000 kJ/kg); (4) has a maximum burning velocity of ≤3.9 in/s (10 cm/s) when tested at 73.4° F. (23.0° C.) and 14.7 psia (101.3 kPa) in dry air. A Class A refrigerant is understood according to ASHRAE Standard 34 § 6.1.2 (2019) as having an OEL (occupational exposure limit) of 400 ppm or greater.

Many of such refrigerants have a low global warming potential (GWP), e.g., a GWP of 500 or lower.

### General Notes

All combinations of the foregoing concepts and additional concepts discussed herein (provided such concepts are not mutually inconsistent) are contemplated as being part of the subject matter disclosed herein. The terminology explicitly employed herein that also can appear in any disclosure incorporated by reference should be accorded a meaning most consistent with the particular concepts disclosed herein.

The drawings are primarily for illustrative purposes, and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments can be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments cannot have been presented for a specific portion of the innovations or that further undescribed alternate embodiments can be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments can be utilized and functional, logical, operational, organizational, structural and/or topological modifications can be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For example, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

The phrase “based on” does not mean “based only on,” unless expressly specified otherwise. In other words, the phrase “based on” describes both “based only on” and “based at least on.”

In addition, the disclosure can include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein can be implemented in a manner that enables a great deal of flexibility and customization as described herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Less specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A fitting comprising:
a nipple comprising:
a first annular groove along a radially-outer surface of the nipple;
a second annular groove distal to the first annular groove, the second annular groove also along the radially-outer surface of the nipple; and
a distal end distal to the first annular groove and the second annular groove, the distal end adapted and configured for insertion within a cut end of tubing having a complementary inner diameter;
a malleable crimping sleeve positioned radially over at least a portion of the first annular groove, the second annular groove, and the distal end of the of the nipple, the malleable crimping sleeve comprising:
a locking rib adapted and configured to:
sit radially over, but not within the first annular groove of the nipple when in an uncrimped state; and
engage with the first annular groove of the nipple upon crimping; and
a retaining ring seated within the second annular groove of the nipple and engaged with complementary geometry of the malleable crimping sleeve to distally retain the malleable crimping sleeve such that the locking rib sits radially over, but not within the first annular groove of the nipple when in an uncrimped state.

2. The fitting of claim 1, wherein the retaining ring is a split bushing seated on a radially outer surface of the nipple.

3. The fitting of claim 1, wherein the fitting consists of metal.

4. The fitting of claim 1, wherein the fitting further comprises a swivel end that defines a conical profile.

5. The fitting of claim 4, wherein the conical profile has a 45° slope.

6. The fitting of claim 4, wherein a gasket can be inserted into the conical profile.

7. The fitting of claim 1, wherein the nipple comprises additional annular grooves.

8. The fitting of claim 7, wherein the nipple comprises additional retaining rings seated within the additional annular grooves.

9. The fitting of claim 7, wherein the additional retaining rings includes O-rings.

10. The fitting of claim 1, wherein the nipple defines a plurality of barbs on a radially outer surface of the nipple.

11. A kit comprising:
the fitting of claim 1; and
a length of composite HVAC/R line set tubing.

12. The kit of claim 11, further comprising:
instructions for attaching the fitting to the length of composite HVAC/R line set tubing.

13. The kit of claim 11, further comprising:
a crimping jaw complementary to the malleable crimping sleeve, the crimping jaw comprising one or more annular crimping points and one or more alignment bosses.

14. A system comprising:
a length of composite HVAC/R line set tubing; and
the fitting of claim 1 coupled to at least one end of the length of composite HVAC/R line set tubing.

15. A method for installing a malleable crimping sleeve over a fitting, the method comprising:
providing a tube having a composite HVAC/R line set tubing;
advancing a cut end of the tube over the nipple of the fitting of claim 1;
placing the malleable crimping sleeve of the fitting over the cut end of the tube such that:
the locking rib of the malleable crimping sleeve is engaged with the first annular groove of the nipple upon crimping; and
the retaining ring of the fitting is seated within the second annular groove of the nipple and engaged with complementary geometry of the malleable crimping sleeve to distally retain the malleable crimping sleeve such that the locking rib sits radially over;
placing a crimping jaw over the cut end of the tube, such that one or more crimping points and corrugation valleys are radially over the first annular groove and the tube; and
applying force to the crimping jaw, thereby forming a gas-tight seal between the cut end of the tube and the fitting.

16. A fitting comprising:
a nipple comprising:
a distal end distal to a first annular groove and a second annular groove of the nipple, the distal end adapted and configured for insertion within a cut end of a tube having a complementary inner diameter; and
one or more annular grooves along a radially-outer surface of the nipple;
a malleable crimping sleeve positioned radially over at least a portion of the one or more annular grooves, wherein the malleable crimping sleeve is configured to compress the cut end of the tube onto the one or more annular grooves to allow for deformation of the cut end of the tube such that a diameter of the cut end of the tube has a radial deflection between 0.012 and 0.040 inches (0.305 and 1.016 mm) relative to its pre-crimping state.

17. The fitting of claim 16, wherein the malleable crimping sleeve further comprises one or more complementary projections on a radially-surface, the one or more complementary projections axially aligned relative to the one or more annular grooves.

18. A kit comprising:
the fitting of claim 16; and
a length of composite HVAC/R line set tubing.

19. The kit of claim 18, wherein the crimping points of the crimping jaw axially aligned relative to the one or more annular grooves.

20. A method for installing a malleable crimping sleeve over a fitting, the method comprising:
providing a tube having a composite HVAC/R line set tubing;
advancing a cut end of the tube over the nipple of the fitting of claim 16;
placing a crimping jaw over the malleable crimping sleeve and the cut end of the tube; and
applying force to the crimping jaw, thereby:
forming a gas-tight seal between the cut end of the tube and the fitting; and
deforming the cut end of the tube to impart a radial deflection between 0.012 and 0.040 inches (0.305 and 1.016 mm) relative to its pre-crimping state.
